(19) United States
(12) Patent Application Publication
(10) Pub. No.: US 2002/0188524 A1
(43) Pub. Date: Dec. 12, 2002

(54) Method for placing/receiving order using electronic mail

(76) Inventor: Hidetaka Shimizu, Tokyo (JP)

Correspondence Address: BIRCH STEWART KOLASCH & BIRCH, PO BOX 747, FALLS CHURCH, VA, 22040-0747, US

(21) Appl. No.: 10/123,183

(22) Filed: Apr. 17, 2002

(30) Foreign Application Priority Data
Apr. 26, 2001 (JP) 129880/2001

(51) Int. Cl. G06F 17/60

(52) U.S. Cl. 705/26; 709/206; 709/246

(57) ABSTRACT

A method of an order-maker placing an order and an order-receiver receiving the order, realized in an environment where electronic mail is available. The order-maker stores product-order information in an electronic mail attachment file, converts the file into a predetermined language format, and sends the file to the order-receiver. The order-receiver re-converts the received electronic mail attachment file to extract the order data, allocates the order, and instructs delivery. Also, an order condition may be set such that approval by an approving-user is needed for all orders or only for orders of a certain amount of money or more. A previously registered order-maker can register an additional order-maker to enable ordering for a plurality of users, thereby making it easy for purchase budget control, etc. and making it possible to re-order using the previous order history.

### BACKGROUND OF THE INVENTION

1. Field of the Invention

The present invention relates to placing and confirming orders for, for example, various office supplies by electronic mail (E-mail), and promptly delivering the ordered supplies to an order-maker. Specifically, the present invention relates to a method for placing/receiving an order such that order-placing information and order-confirmation information is created as data on conventional spreadsheet software, and the data is automatically converted to a predetermined language for sending/receiving by E-mail.

2. Description of the Related Art

In recent years, the Internet and information network systems using the Internet have been developed and have become remarkably widespread. For placing/receiving orders for supplies, a transition is taking place from the conventional methods using telephones, fax machines, and the like, to electronic commerce (E-commerce) such as online shopping and online trading using the Internet and so on.

In the office-supplies field, currently, such a system has been established in which a user selects supplies by looking at catalogs, places orders by sending fax messages using order-sheets to a dealer or an order-receiving center (hereinafter, simply referred to as a “dealer”), and the dealer confirms the user's order and then instructs delivery of the supplies. Also, there is another method of using a CD-ROM as an electronic catalog instead of using a printed catalog.

Recently, a system has been realized in which a pre-registered user accesses a homepage through a dealer's WWW server using a WWW browser and the Internet, and browses the member's homepage catalogs and the product-search screens in order to place an order online.

Further, a system has been proposed in which a user sends to the dealer an E-mail with the ordered supplies entered in the body of the E-mail message or as an attachment, and the dealer performs the order processing in accordance with the received E-mail message.

With the above-described order placing/receiving method which uses a Web-environment and E-mail on the Internet, users can easily place orders from personal computers on their desktops. Thus it is possible to substantially reduce the work required to place orders as compared with the method using order sheets and a fax machine.

However, in the case where the order-maker is an enterprise, there are many restrictions on the use of the Internet from the standpoint of network security. Preventative measures are generally adopted such that malicious intrusion, through the WWW server, from the outside is prevented by a firewall.

Also, when a group of programs called UUCP (Unix-to-Unix Copy Program) is used as a connection program in order to lower the communication cost, a dial-up IP connection to the Internet is not possible, thus the WWW cannot be used.

As described above, in some cases, order-makers cannot place orders using ordinary E-commerce procedures in a Web environment through the Internet. To make the E-commerce procedures possible, it is necessary to reconfigure the overall system or change the security setting.

Further, in the order-placing/receiving method using conventional E-mail, the order-receiving side needs to open the message of an E-mail and an attachment file which are created by various mailers (mailing software), manually input the order data once again for order processing, perform data conversion for processing, and so on. These operations are needed for each order received, thus the job is very complicated and needs a lot of work.

Also, when an order-maker in an enterprise, etc. places an order using E-mail, if the amount of money for the order is considerably high, it is desirable to carry out some kind of approving processing by a superior or an accounting personnel before the actual order is placed. However, in the conventional order-placing/receiving method, an efficient approval function integrated with an order-placing function has not been considered.

Further, it is desirable for purchase planning thereafter and for controlling the budget if the order-maker can be informed of the cumulative purchase amount for a fixed time-period every time he or she places an order. However, the current situation is that an adequate method is not provided for that purpose.

Additionally, in the conventional order-placing/receiving method, a single user places an order for supplies in order to use the supplies for his/her own use, and the ordered supplies are generally distributed to that user. However, in some companies, there are demands for one department to place orders for their own department and other departments together, or to place only orders for other departments in order for the supplies to be distributed to each department individually.

In such a case, conventionally, each individual department needs to have an environment in which an order-placing/receiving system is available. Specifically, it is necessary for each department terminal to be equipped with an order-placing/receiving program. Thus a big problem arises in terms of cost.

Also, when placing an order with the same content as a previous order, conventionally, users need to again input the same order-information in the same manner; thus there are demands to provide means to eliminate complicated input operations.

### SUMMARY OF THE INVENTION

Accordingly, it is an object of the present invention to provide an order-placing/receiving method in which a user having restricted use of a Web environment on the Internet can easily place orders and an order-receiver can execute order processing efficiently and promptly.

Also, it is another object of the present invention to provide an order-placing/receiving method having complete approval functions regarding order content.

It is a further object of the present invention to provide an order-placing/receiving method which can simplify purchase planning and budget control by informing at least the order-receiver of the purchase-budget amount in a fixed time period, the purchase amount this time, and the cumulative purchase amount in a fixed time period.

It is still another object of the present invention to provide an order-placing/receiving method in which a plurality of users can practically place orders by allowing a certain user to place orders instead of the other users using a single order-placing program.

It is a still further object of the present invention to provide an order-placing/receiving method which simplifies the order-placing input operation by making it possible to use the order history directly.

In order to achieve the above objects, according to a first aspect of the present invention, there is provided a method for placing/receiving an order using electronic mail in an order-placing/receiving system having an order-maker and an order-receiver in an environment where electronic mail is available, including: storing, at the order-maker's side, order-information for products into an electronic-mail attachment file, automatically converting the order-information into a predetermined language format, and sending the electronic mail to the order-receiver; and automatically reconverting, at the order-receiver's side, the order-information in a received electronic-mail attachment file to extract the order data in order to allocate order and then instruct delivery.

In the first aspect of the present invention, the method may further include: entering, at the order-receiver's side, order-confirmation information including the order data and the order allocation result into the message of the electronic mail and storing the information into an attachment file; and automatically converting the order-confirmation information into a predetermined language format in order to reply to the order-maker.

Also, in the first aspect of the present invention, the method may include: making, at the order-maker's side, the order-information using a spreadsheet-software template which is distributed by the order-receiver in advance; and storing the order-information into an attachment file.

Further, in the first aspect of the present invention, the predetermined language format may be an XML.

With the above-described arrangement, even if the user has restricted use of the Web environment on the Internet in view of security, by having at least an environment where Email is available, a user can place online-orders for desired products and purchase them by normally operating a personal computer. Accordingly, changing the settings of the security system in a company is not needed. Also, the user needs only a general-purpose mailer, spreadsheet software, and conversion software; thus the economic burden is small.

In addition, since the order-information and order-confirmation which are stored in the E-mail attachment file are, for example, automatically converted to XML format and then transmitted for data extraction, the workload conventionally required for data copying and conversion is not required in this case, thus it is possible to reduce the manpower and increase the order-processing speed.

Also, because both the order-placing side and the order-receiving side can store order-placing/receiving data digitally, it is possible to realize a system which simplifies performance management for purchase history control and marketing control.

Furthermore, in the first aspect of the present invention, an approving-user, who gives approval for the order content, may he established by the order-maker in advance to be registered at the order-receiver's side, and the order-receiver may validate the order-content included in the order-information and perform order processing when the approval of the approving-user is obtained after the order-receiver who has received the order-information sends the order-information to the approving-user.

Moreover, in the first aspect of the present invention, the approval of the approving-user may always be needed regardless of the order-amount at one time.

Also, in the first aspect of the present invention, the approval of the approving-user may be needed when an order-amount at one time is not less than a predetermined amount of money.

With these arrangements, by determining, for each individual order, if it is approved or unapproved, it is possible to prevent wasteful spending, and utilize the purchase budget effectively.

Further, in the first aspect of the present invention, the order-receiver who has received the order may inform, at least, the order-maker of the purchase budget amount for a fixed time period set by order-maker, the purchase amount this time, and the cumulative purchase amount in the fixed time period.

With this arrangement, purchase planning and budget control by the order-maker becomes easy, thus the workload of the order-maker for this clerical work can be reduced.

Furthermore, in the first aspect of the present invention, a previously registered order-maker may set an additional order-maker in advance and send the additional order-maker information to the order-receiver, the order-receiver may register the additional order-maker information, and at the same time, send the additional order-maker information to the previously registered order-maker to capture the information in the previously registered order-maker's terminal, thus the previously-registered order-maker can perform the order-placing processing for the additional order-maker.

With this arrangement, when only a single user (department) is equipped with the order-placing program, by registering an additional user (additional order-maker), it is possible to place an order for a plurality of users including the other departments. Accordingly, it is not necessary to install the order-placing program in every department, thus the workload of the user is reduced and the cost can be lowered.

Moreover, in the first aspect of the present invention, the order-maker and the order-receiver may store previous order-information as a history, and by the order-maker's selection of the order-information from the history, placing/receiving a re-order using the order-information may be possible.

With this arrangement, when placing an order having the same content with a previous order, the input operation becomes easy, thus there is an effect for reducing the workload of the user.

### BRIEF DESCRIPTION OF THE DRAWINGS

FIG. 1 is a schematic diagram illustrating an embodiment of the present invention;

FIG. 2 is a template configuration diagram of an embodiment of the present invention;

FIG. 3 is a flowchart illustrating a general flow of order placing/receiving processing of an embodiment of the present invention;

FIG. 4 is a flowchart illustrating registration processing of the approval function of an embodiment of the present invention;

FIG. 5 illustrates an input screen at initial-registration;

FIG. 6 illustrates an electronic mail when user-registration is complete;

FIG. 7 illustrates an electronic mail when setting an approving-user;

FIG. 8 illustrates a screen when user-registration information is read;

FIG. 9 is a flowchart illustrating a main part of order-placing/receiving processing including an approval function;

FIG. 10 illustrates an electronic mail for requesting approval;

FIG. 11 illustrates an electronic mail for reporting an approval request;

FIG. 12 illustrates a selection screen for approval-requesting orders;

FIG. 13 illustrates the content of an approval file;

FIG. 14 illustrates an electronic mail for reporting an approval result;

FIG. 15 illustrates an electronic mail for reporting an approval result;

FIG. 16 is a flowchart illustrating the registration processing of an additional user;

FIG. 17 illustrates a “change settings” submenu screen;

FIG. 18 illustrates a settings and input screen for additional-user information;

FIG. 19 illustrates an electronic mail to be sent to an additional user;

FIG. 20 illustrates a screen when additional user information is read;

FIG. 21 illustrates an input screen when additional user information is updated;

FIG. 22 illustrates an input screen when placing a new order;

FIG. 23 illustrates a screen when re-ordering; and

FIG. 24 illustrates a screen when re-ordering.

### DESCRIPTION OF THE PREFERRED EMBODIMENTS

In the following, a description will be given of an embodiment of the present invention with reference to the drawings. In this embodiment, the present invention is applied to an office-supplies order placing/receiving system. However, the present invention is not restricted by the quality and kind of supplies (including services) to which it applies.

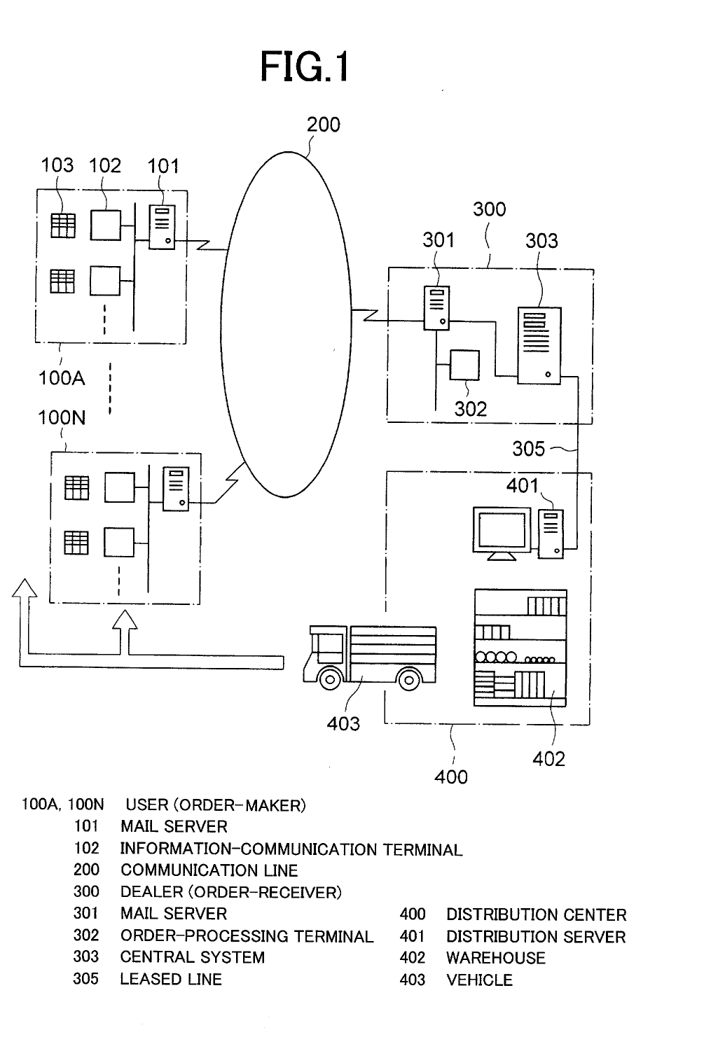

FIG. 1 is a schematic diagram of the overall system according to an embodiment of the present invention.

In FIG. 1, 100A, . . . ,100N denote users who act as order-makers, that is, a concept including individuals other than business entities such as companies and so on.

Each user (in the following, the reference numeral 100 is assigned for convenience) has a mail server 101 and a plurality of information-communication terminals 102 connected to the mail server 101. Here, the information-communication terminals 102 are generally desktop-type or notebook-type (laptop) personal computers, but may be personal digital assistants which can be used in a so-called mobile environment. However, these personal digital assistants 102 need to have, at least, a mailer, general-purpose spreadsheet software (for example, Microsoft's “Excel™”, etc.), and software (for example, Infoteria's “iMaker for Excel™”) which converts template-input data to an XML (Extensible Markup Language) file. In this regard, XML is an extension of HTML (Hypertext Markup Language), which is well known as a homepage description language, and makes HTML available for data communication between computers. XML has been known for its excellent data-representing ability and expandability.

Reference numeral 103 denotes a template of the above-described spreadsheet software, and the order-information of an order sheet 1032, described below, which is created by the terminal 102 based on the template 103, is to be sent as an E-mail attachment file from the mail server 101.

Also, when the user 100 is a corporation, the above described mail server 101 and the terminal 102 can constitute a corporate internal LAN (Local Area Network) such as an Ethernet network coupled with a WWW server and a Proxy server. However, the user's internal network is not the main topic of this invention, so that its configuration will be omitted. In this regard, even if the user 100 is an individual or a small company which is not provided with a mail server, only connection to a provider's mail server via the communication line 200 is required.

The communication line 200 includes a public circuit, such as an ISDN line or an analog telephone line, which extends to the provider.

Further, 300 denotes a dealer or an order-receiving center as an order-receiver, which is a product order-placing destination. Alternatively, it denotes the main office of the operator (enterprise) of the overall order-placing/receiving system which supervises dealers. In the present embodiment, a description is given that the reference numeral 300 is a dealer, however, so-called dealers may be provided for each district of the overall system, and there is an operator of the order-placing/receiving system who supervises those dealers. This operator has a central system 303 described below.

The dealer 300 includes a mail server 301, an order-processing terminal 302 for an operator, and a central system 303 as a computer system for performing order allocation (inventory reservation) processing and so on.

The mail server 301 is configured to receive the E-mail (including an attachment file of XML format) which is sent from the user 100, to re-convert it to the order data of a predetermined format by an internal program, and to send the data to the central system 303.

Also, the terminal 302 and the mail server 301 store the order-confirmation information including the order-allocation result of the ordered product from the central system 303 into an attachment file of spreadsheet software and write the information in the E-mail message at the same time, attach the attachment file, which is converted to XML format, to the E-mail message to reply it to the mail address of the user 100.

The central system 303 performs order-allocation based on the order data received from the mail server 301, and instructs delivery to the distribution server 401 of the distribution center 400 based on the allocation result. Also, when there is no inventory, that information is included in the order-confirmation information of the E-mail which is returned via the mail server 301.

Here, when some of the ordered products are out of stock, there are several options to be asked to the user 100: whether the shipment should be made when all the products are picked after waiting for the replenishment of the products which is short of stock; whether only the available products should be shipped in advance without the products which is short of stock; whether the products short of stock should be cancelled, or they should be superseded by the alternative products. The presentation of these options and selection of the user 100 can be carried out through the communication by E-mail with the user 100.

In the distribution center 400, the products which have been instructed to be shipped by the distribution server 401 are taken out from the warehouse 402, are loaded on the vehicle 403, and are distributed to the user 100.

Next, a description will be given of the template 103 of spreadsheet software to be used by the user 100 in this embodiment.

First, the above-described template 103 is provided to the user 100 who has registered in advance as a member of this order-placing/receiving system by downloading from the system operator's homepage together with the order-making program for using this system. Alternatively, the template is provided by a suitable medium (CD-ROM, floppy disk) from the system operator. In this regard, the printed product catalogs are also distributed to the user 100. The user installs the template 103 on his/her terminal 102 together with the above-described order-placing program before using this system.

After installation, the user opens a user-information storage sheet 1033 described below in the template 103, inputs a user-code which has been given when becoming a member and a dealer-code, and presses the send-button in the sheet 1033.

The terminal 102 of the user 100 converts the data which has been input into the user-information storage sheet 1033 to XML format by the above-described predetermined conversion software, and automatically sends to the mail server 301 of the dealer 300 as an E-mail attachment file.

The mail server 301 automatically re-converts the received E-mail attachment file to translate the user information, and sends this information to the central system 303 to save the information. At the same time, the operator assigns and issues an ID and a password for order-placing for the user-information, and returns the E-mail with the data as the E-mail attachment file to the user 100. At this time, the assigned ID and the password for placing orders are stored in the central system 303 too. In this regard, by reading the above-described attachment file, the user 100 becomes available for using the order-placing/receiving system.

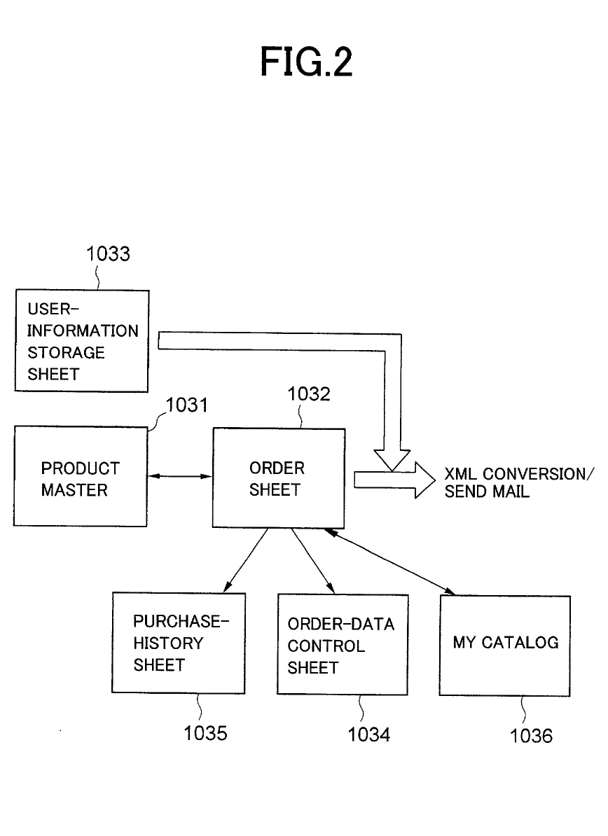

The configuration of the template 103 will be specifically described with reference to FIG. 2. The template 103 has at least a product master 1031, an order sheet 1032, the user-information storage sheet 1033, an order-data control sheet 1034, and a purchase-history sheet 1035. Also, the template has order-placing sheets called “my catalog” 1036 according to the necessity.

In the following, information to be stored or input into each sheet is described.

First, the product master 1031 stores attributes such as an order-code (product-code) to be handled by this system, a product name, a fixed price, a product category, and an ecology mark (eco-mark, green mark, etc.).

The order sheet 1032 is an input sheet for entering an order-code, an order quantity, an account code, a line memo (comment for each order-code), and a request delivery-date. These input columns are arranged in a predetermined format. In this regard, the order-code and the order-quantity are mandatory input items.

The user-information storage sheet 1033 stores a user-code, a dealer-code, an order-placing ID, an order-placing password, a name of a person in charge of order-placing, and the person's mail address.

The order-data control sheet 1034 is a sheet for storing and controlling the order number issued from a dealer for each order-placing.

Also, the purchase-history sheet 1035 is a sheet for recording and controlling the product names purchased in the past, the quantity thereof, and the number of times of the purchases.

Further, a user-specific my-catalog 1036 listing regular products which each user 100 frequently places orders is created. Thus only by inputting order quantities in this sheet, the user can easily store the order information into the order sheet 1032.

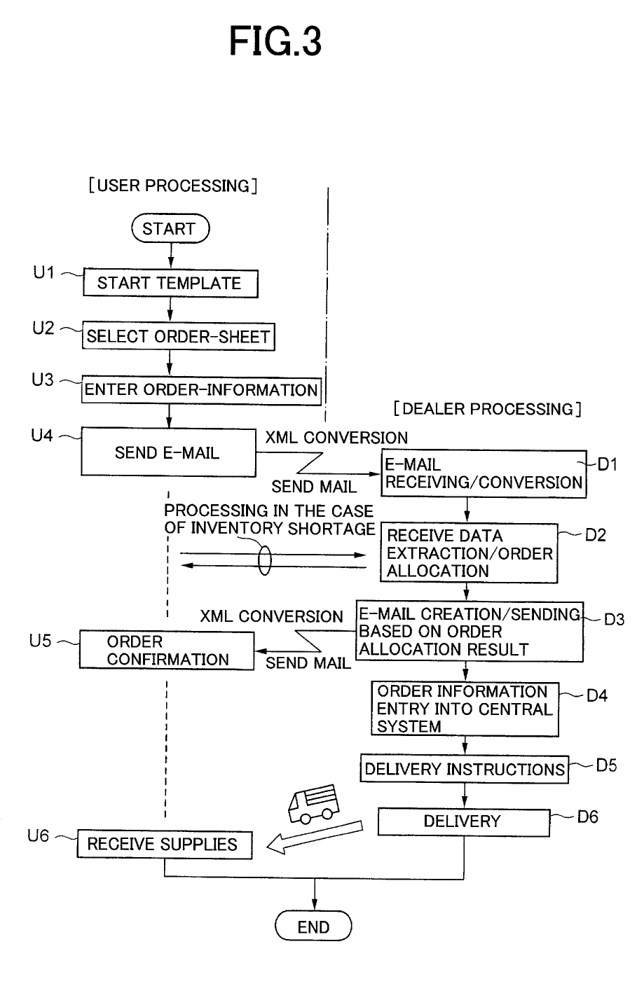

Next, a description will be given of the general flow of the order-placing/receiving processing of the present embodiment with reference to FIG. 3. In FIG. 3, the left-side shows the processing of the user 100 who is an order-maker, and the right-side shows a dealer 300 who is an order-receiver and the distribution center 400.

First, the user 100 starts the template 103 (U1) of the spreadsheet software by the order-placing program from his/her terminal 102 in order to use this system, and selects the order sheet 1032 from the template (U2). Then the user enters, into the input columns, the order-information, such as the product order-codes, the ordered quantities, the account-codes, the line memos, and the requested delivery-date (U3). At this time, with the use of macro functions of the spreadsheet, the product name can be displayed on the order-sheet 1032 only by entering an order-code with automatic reference to the product master 1031.

Then the user clicks the send-button in the sheet to send the E-mail (U4).

With this operation, on the terminal 102, the mailer is started and the user-information in the user-information storage sheet 1033 (the user-code, the dealer-code, the name of the person in charge of order-placing, and the mail address of the person) is added to the order information which is input into the above-described order-sheet 1032, and this data is created as an E-mail attachment file. Further, the attachment file is automatically converted to XML format by the conversion software and is attached to the E-mail message to be automatically sent to the dealer 300.

After receiving the E-mail, the dealer 300 re-converts (D1) the attachment file to a predetermined data format, extracts the received data, and performs order allocation (D2). In this regard, in the case of inventory shortage, the processing is performed as described above, and the user's intention is confirmed by exchanging E-mails, etc. with the user 100 according to the necessity. Here, a description is given on the assumption that all of the ordered products have enough inventory.

The dealer 300, for example, fills the order-allocation result in the E-mail message, at the same time, fills the order-receiving product list and purchase amount in the Email message and the attachment file too for order-confirmation of the user 100, and converts the information in the attachment file to XML format to be sent to the order-maker of the user 100 (D3).

Here, as described below, at the user 100 side, when an approval is required for each order by a person other than the order-maker himself/herself, the mail-address of the approving-user is registered at the dealer 300 side in advance, and when the order-maker places an order, the dealer 300 may send E-mail to the approving-user and by getting an approval, performs the order processing.

The user 100 who has received a return-mail from the dealer 300 with an XML-format attachment file confirms the order content from the mail content (U5).

At the same time, at the dealer 300, the order information is entered into the central system 303 (D4). Next, the distribution server 401 in the distribution center 400, which is a client who is connected to the central system 303 via a leased line, instructs deliveries (D5).

When the delivery is instructed, the order product is delivered to the user 100 at a predetermined date and time (U6), and the user 100 receives the product (U6).

At the user 100 side, when a series of order processing is complete, by reading the received attachment file in step U5 described above, the order-data control sheet 1034 and the purchase-history sheet 1035 are created and stored in the terminal 102 and so on. This simplifies the order-placing/purchase status control.

In this regard, in the present embodiment, a description is not given of the product-payment settlement method, however, for example, the total purchase amount for a fixed period may be withdrawn from the designated bank account.

In the following, another embodiment of the present invention will be described. This embodiment relates to an approval function which needs an approval of the order content by a third person prior to the actual order by a user 100.

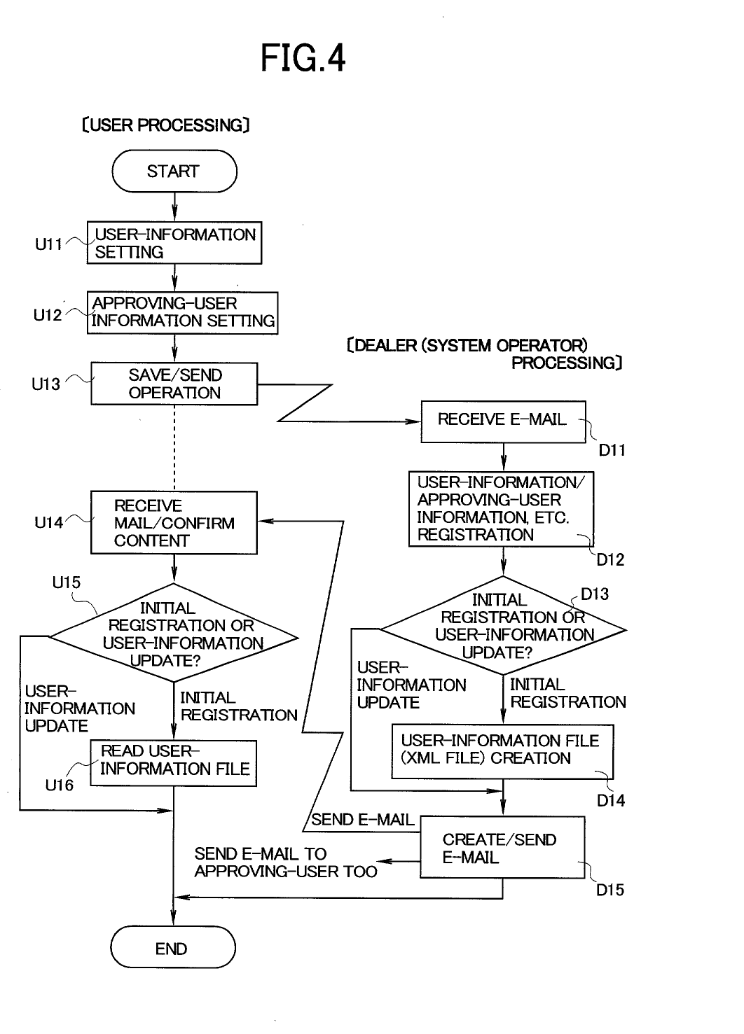

FIG. 4 is a flowchart illustrating registration processing of this approval function at the user 100 side and a dealer 300 (operator of order-placing system in this embodiment) side. This registration processing is performed by the order-placing program installed in the terminal 102 and the program installed on the operator-side server of this system or on the central system.

In the following, a description will be given with reference to the flowchart in FIG. 4, the terminal screen of the user-side, and the contents of the E-mails sent/received.

Here, when the user 100 has not been registered as a user of this order-placing/receiving system, registration of an approval function is performed as a part of the “initial registration or application” processing in the user registration. When the user 100 has already been registered, registration of an approval function is performed as a part of the “user-information update” processing.

First, the user 100 sets his/her own information (U11 in FIG. 4). For the setting-input screen, for example, at the initial input time, the input screen as shown in FIG. 5 is used. In this regard, almost the same setting-input screen is used as the screen of the user-information update time. These input screens are started by the order-placing program installed on the terminal 102 of the user 100.

The user-information to be input in the screen shown in FIG. 5 includes a user-code, a dealer-code, an order-maker name, a mail address of the order-maker, an SMTP server-name, an SMTP port number, and so on. In this regard, the user-code and the dealer-code is informed to the user 100 in advance of the initial registration.

Also, the user 100 sets the information regarding an approving-user who gives an approval to the order-content of the order-maker as approving-user information (U12). The approving-user is, for example, a superior in the department to which the order-maker belongs or an accounting personnel.

As for an approving-user information, a first item is whether an approval is required or not. This means that the user 100 can select: (1) “direct order”; (2) “an approving-user order (always approval is required)”; and (3) “an approving-user order” (approval is required when the order-amount is a certain amount or more). (1) “direct order” is an order-placing type which does not require an approval. (2) “an approving-user order (always approval is required)” is an order-placing type which requires approval,regardless of the order-amount. (3) “an approving-user order” (approval is required when the order-amount is a certain price or more) is an order-placing type which requires approval in the case where the order-amount is over the certain amount. This certain amount can be input arbitrarily as shown in the figure.

Further, for the approving-user information includes items as follows: an approving-user name, a department name, and a mail-address.

These pieces of information is recorded in the above-described user-information storage sheet 1033. When the user 100 clicks the “save & send” button, the information is recorded in that terminal 102 and at the same time converted to XML format, and sent as an E-mail attachment file to the mail server 301 of the system operator (U13, D11).

The system operator opens the attachment file of the received E-mail, and registers the user-information and approving-user information shown in FIG. 5 in the central system 303 (D12).

In this regard, the processing of the system-operator side described below is automatically executed by the programs on the mail server 301 and the central system 303, however, the processing can be performed manually by the operator.

Next, at the system-operator's side, it is determined whether the user is in the “initial registration” stage or “user-information update” stage (the information is included in the E-mail and the attachment file which are sent from the user 100) (D13). In the case of “initial registration”, a user-information file (XML file) is created (D14). This file includes, as described above, the order-placing ID and the password, etc. which have been assigned to the user 100, and also includes the information for allowing to use this system as a registered user by reading the file into the terminal 102 of the user 100.

In this regard, in the case of “user-information update”, the above-described step D14 is bypassed.

Next, the system operator creates and sends the E-mail to the user 100 and the approving-user (D15). Here, if the user 100 is an “initial registration” user, the operator sends the user-information file which is created in step D14 as an attachment file.

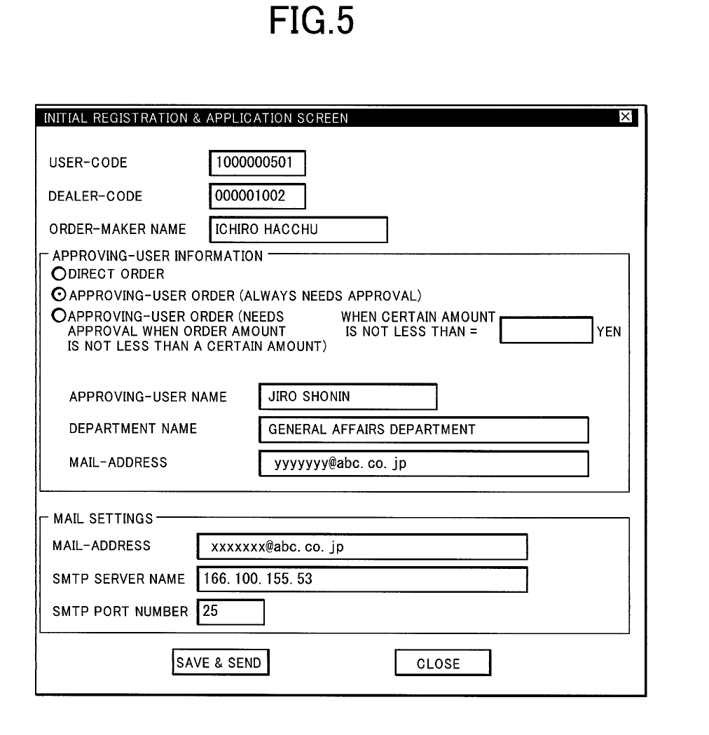

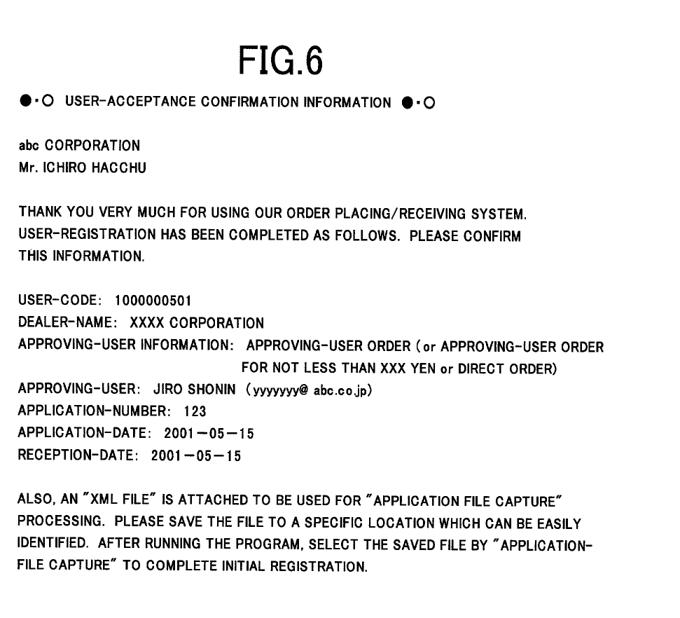

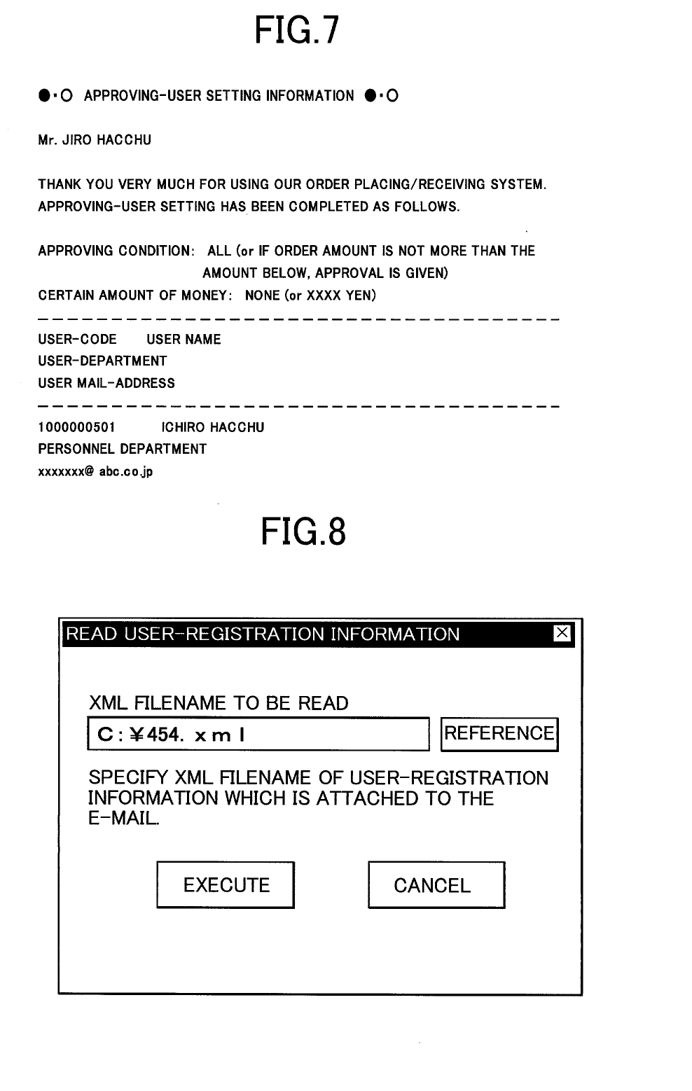

FIG. 6 shows the content of the E-mail sent to the “initial registration” user, and FIG. 7 shows the content of the E-mail sent to the approving-user.

After the “initial registration” user 100 who has received the E-mail shown in FIG. 6 confirms the content (U14), the user reads the user-information file (XML file) by the screen shown in FIG. 8, thus the user becomes a registered user who can use this system (U15 and U16). For the “user-information update” user 100, the confirmation mail is sent from the system operator-side, but the attachment file is not sent, thus the file-read processing is not performed.

Also, the approving-user confirms the content of the E-mail shown in FIG. 7, and is informed of the user information, the fact of setting as the approving-user, an approving condition (order-placing type), and the setting amount of money.

Next, when changing the approval function, the user 100 changes the approving-user information (including information regarding an approving-user, an order-placing type and the setting amount of money) using the “user-information update” setting input screen (similar to FIG. 5). Thereafter the user clicks the “save & send” button, and the information is sent to the mail server 301 of the system-operator side in the same manner as the “initial registration”. Then the system-operator registers the updated information in the central system 303.

Also, the system-operator sends the updated information to the user 100 and the approving-user as E-mail, and asks for confirmation, respectively.

To delete an approval function, the user 100 can select “direct order-placing” in the setting-input screen of “user-information update” and send it to the system-operator side.

Next, a description will be given of the approval function related part of the actual order-placing/receiving processing after registration of an approval function with reference to the flowchart, the terminal-screen display, and the contents of the exchanged E-mails.

The processing contents described here are executed at the timing of the E-mail sending operation (U4) of the user-side processing and the E-mail receiving/conversion (D4) of the dealer-side processing in FIG. 3.

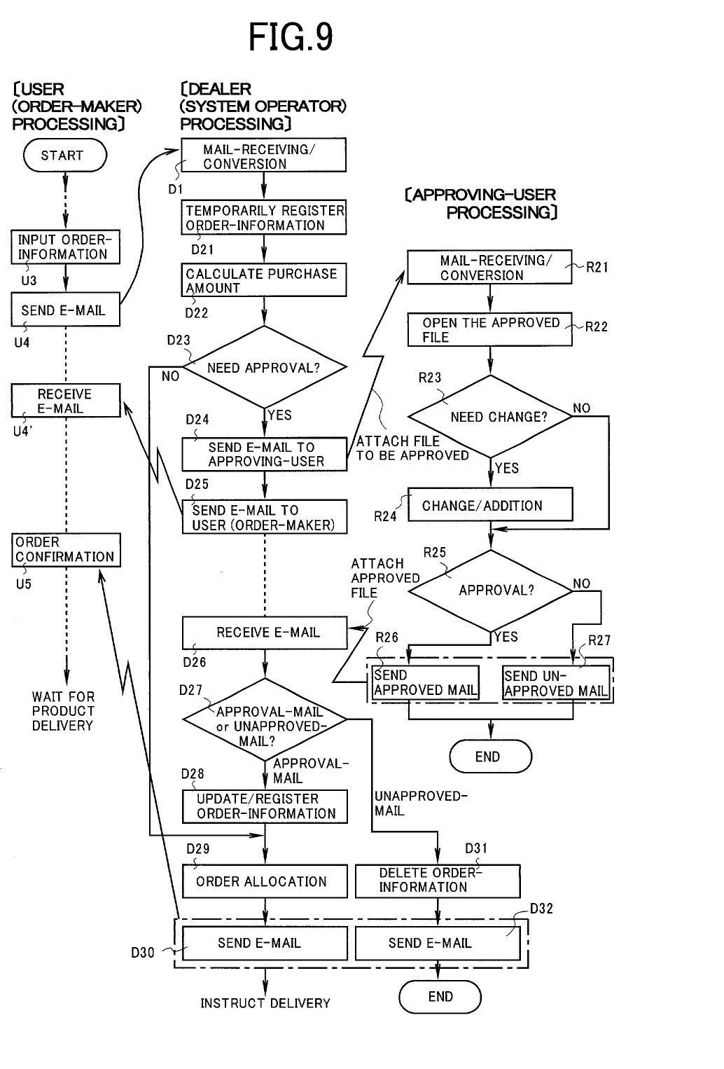

In the flowchart shown in FIG. 9, when the user 100 sends an E-mail with an XML-format attachment file containing user-information, order-information, etc. (U4), the system-operator performs the receiving processing and conversion processing (D1), and extracts the receive data and registers the order information temporarily on the server (D21). Subsequently, the purchase amount of the ordered products is calculated (D22).

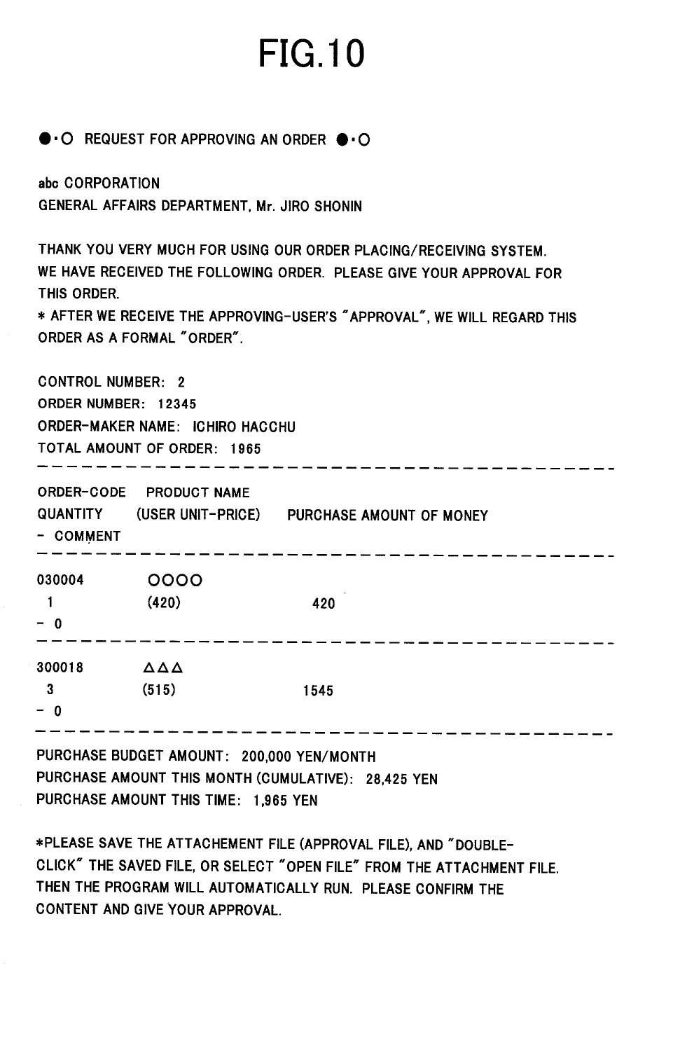

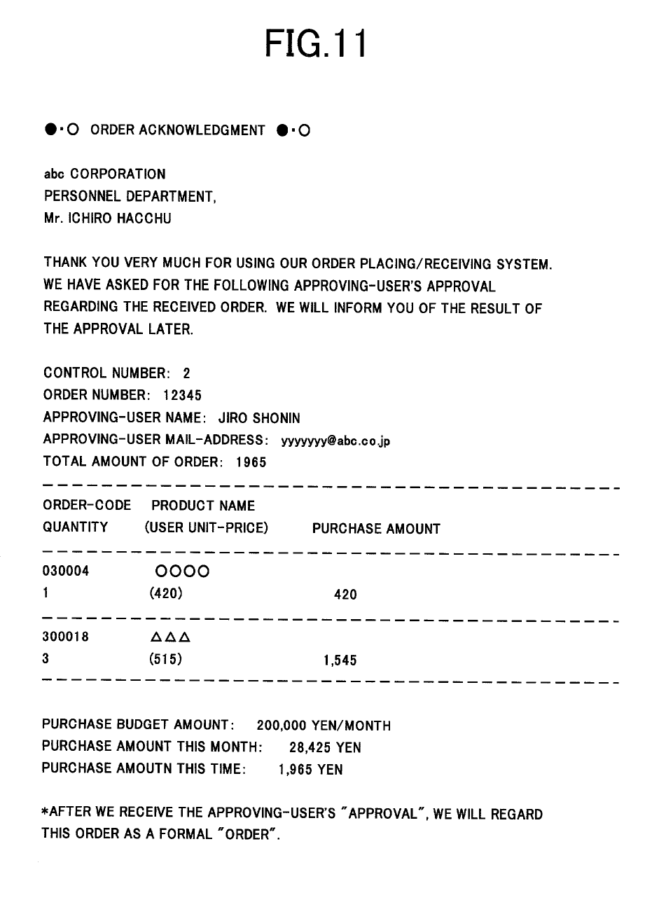

Next, based on the previously registered approval function, a determination is made whether the order is either (2) “an approving-user order (always approval is required)” described above, or the order corresponds to (3) “an approving-user order” (approval is required when the order-amount is a certain price or more) on the basis of the calculated amount in step D22. If the determination result is either of the above cases, a requesting-approval mail as shown in FIG. 10 is sent to the approving-user (D23 and D24). If the order-type is “direct order” other than the above (1) or (2) and an approval is not required, the processing moves directly to the order allocation processing (D29).

In this manner, every time the user places orders, at least the user 100 can be informed, by E-mail, of the purchase budget amount for a certain time period, for example one month, the cumulative purchase amount of this month, and the purchase amount of this time. Consequently, the user 100 has an advantage that he/she can easily make a purchase plan and control budget, and thus the clerical work is reduced.

In this regard, the above-described purchase budget amount for a certain time period is set by the user 100 at user-registration time, and is registered as part of the user information in the central system 303 in advance.

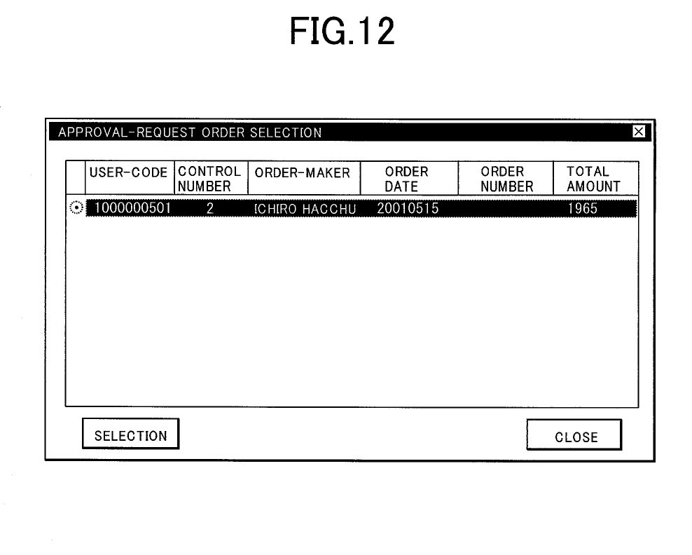

When the approving-user receives the E-mail shown in FIG. 10 and then opens the above-described approval file (R21 and R22), an approval program is started and a requesting-approval order selection screen shown in FIG. 12 appears on the terminal. In this regard, when there are a plurality of approval requests to the same approving-user, the same number of pieces of information as that of the approval requests are shown on the selection screen shown in FIG. 12.

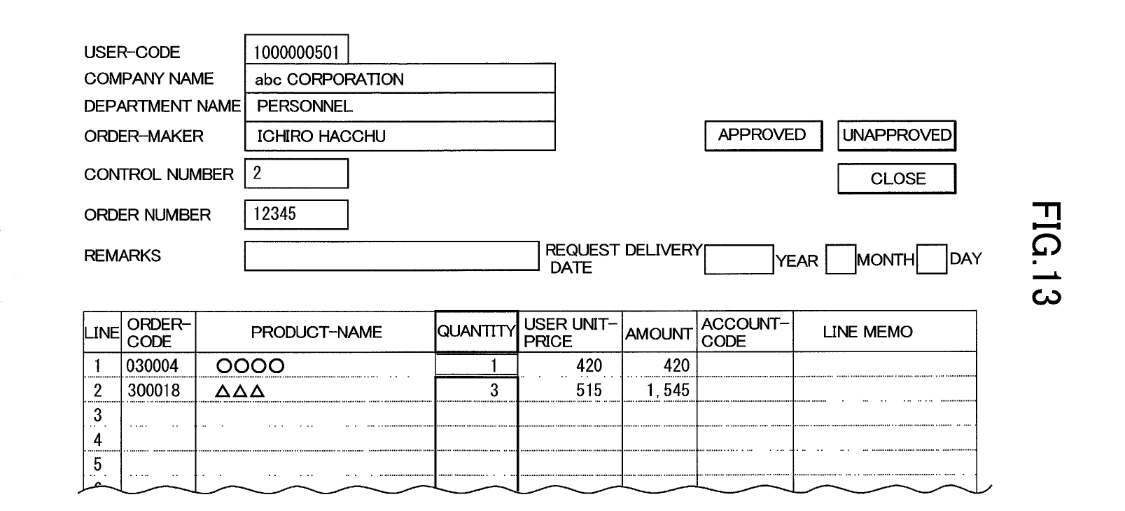

When selecting a desired request from this selection screen, a spreadsheet-software worksheet on which the ordered-content is written is read, and an approval screen as shown in FIG. 13 is displayed.

Here, the approving-user determines the necessity of changing the order-content (including addition) (R23). If a change is required, for example, the approving-user changes quantities of each detail line of the order product on the approval screen (including canceling the order by making the quantity zero). Also, when adding an item, the approving-user enters an item and a quantity in the detail line (R24). Further, when the approving-user has changed quantities, or added items, these changes and additions are appended to the below described E-mail and so on.

After this, the approving-user determines whether the final order-content is to be approved or unapproved (R25). If it is approved, the approving-user clicks the “approval” button on the approval screen in FIG. 13. If all of the items are not approved, the approving-user clicks the “unapproved” button.

By this operation, an approved E-mail or an unapproved E-mail is sent to the dealer 300 side (R26 and R27). In this regard, these E-mails have the attached approval files described above. The approval file is any one of the following: an approved file with the approved original-order content without change, an approved file which is changed and added by the approving-user, and unapproved file (for convenience, this is also called an approval file).

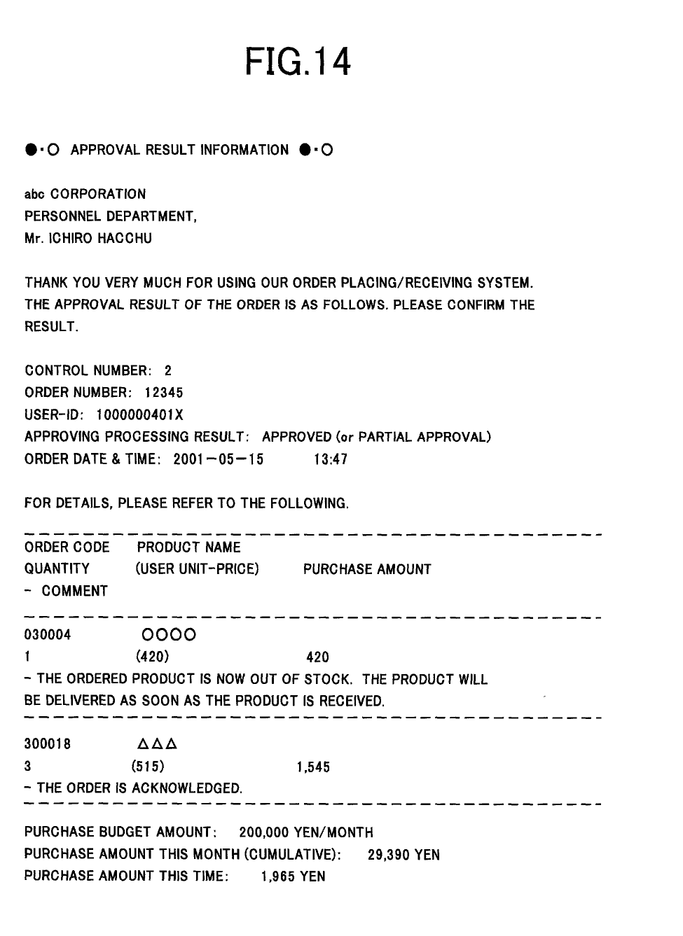

The system-operator receives an approved mail or unapproved mail (D26). If this is an approved mail, the system-operator opens the attachment file and updates the order information (temporarily registered order information) of step D21 by that order information, and registers the order information of the items having quantity other than zero as the final order data in the central system 303 (D27 and D28). Then order allocation is performed (D29), and the E-mail as shown in FIG. 14 is sent to the user (order-maker) 100 (D30).

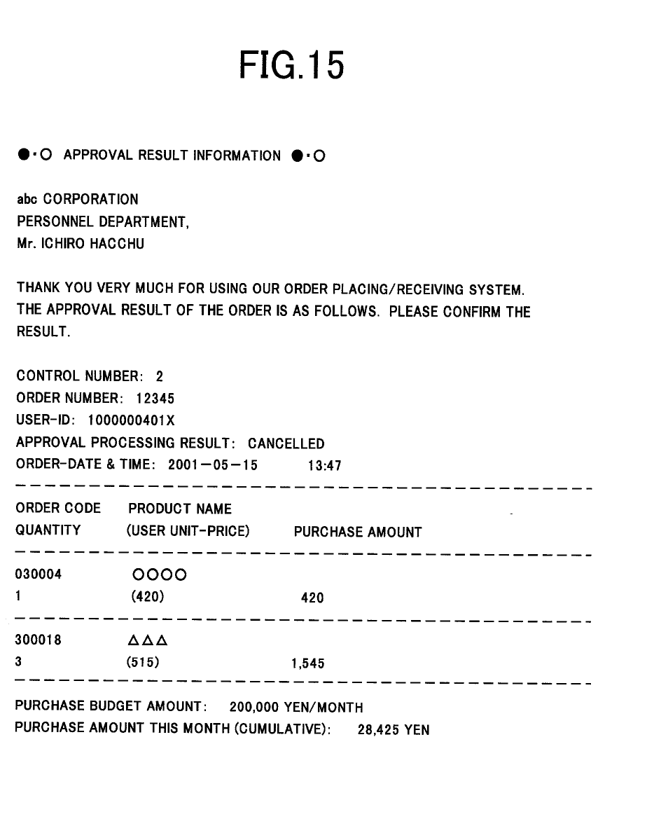

Also, if it is an unapproved mail, the temporarily registered order information is deleted (D31), and the E-mail saying that the order content is unapproved (cancelled) as shown in FIG. 15 is sent to the user (order-maker) 100 (D32). If the order content is approved, the processing goes to delivery instruction.

The user (order-maker) 100 confirms whether the order is accepted or not from the content of the mail (U5), and waits for delivery of the product in case of order acceptance.

Next, a further embodiment of the present invention will be described. In this embodiment, one user (department) can place orders for another user using a single order-placing program, thus a plurality of users can place orders as a result. Accordingly, here, this function is called a “plural user order-placing” function for convenience.

This means that the previously user-registered one user (department) registers another department as an additional user, and this has enabled one department to place orders for another department instead.

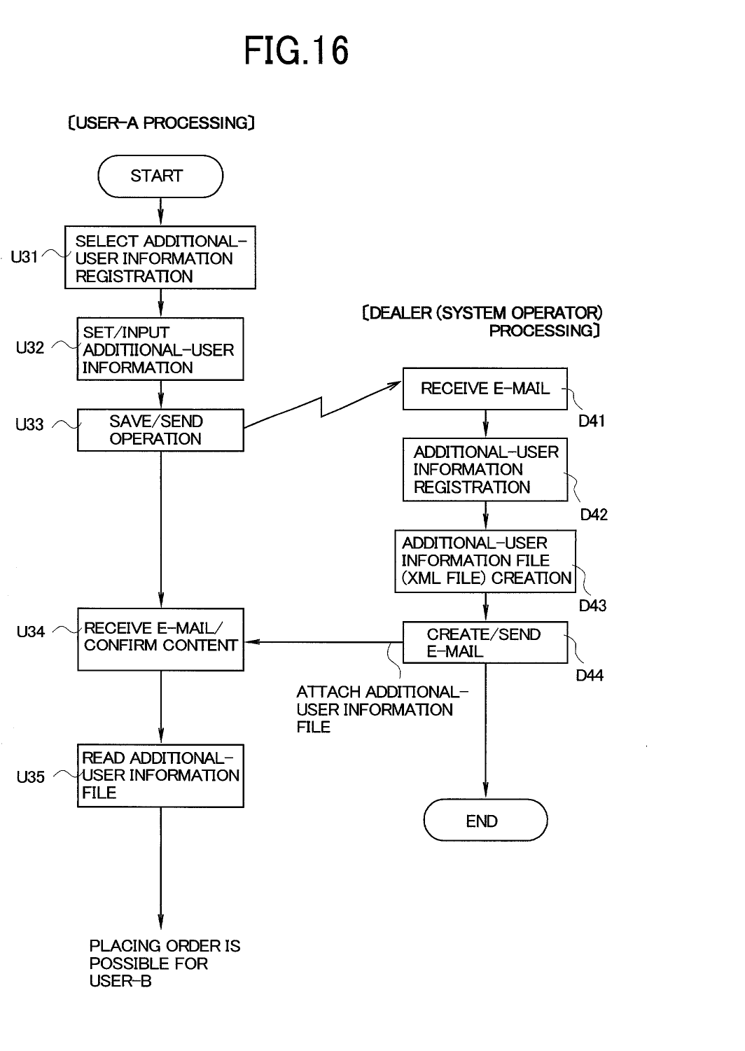

FIG. 16 is a flowchart illustrating the registration processing of a “plural user order-placing” function in this embodiment.

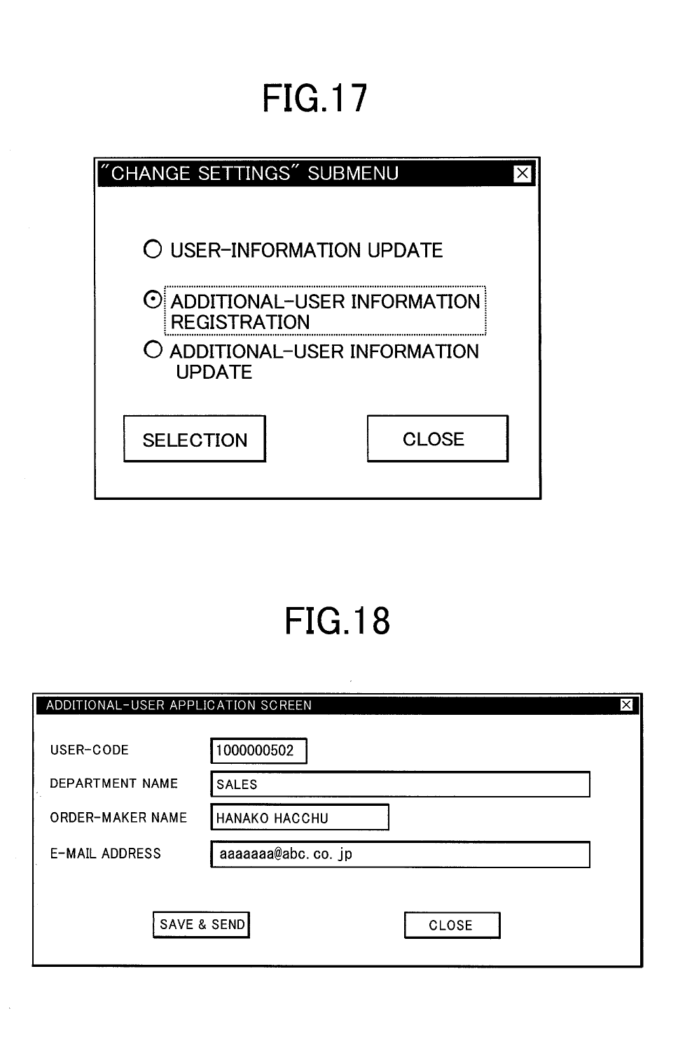

First, the previously registered user A calls up the setting-change submenu as shown in FIG. 17 on the terminal as part of the “user-information update” processing, and selects “registration of additional user-information” (U31). With this operation, an additional-user application screen illustrated in FIG. 18 is shown on the terminal. The user A enters a user-code, a department-code, an order-maker name, and a mail-address of another user (department) B as an additional user-information (U32).

The user-code of the additional user B is, for example, set to “1000000502” in connection with the user-code of the previously registered user A (in this example, “1000000501”). The user-code of this additional user is arbitrarily set at the user's side.

When the user A sets and enters the additional user-information shown in FIG. 18, and then clicks the “save & send” button, the above-described additional user-information is sent to the system-operator as E-mail (U33). In this regard, the send information includes an approving-user information (approving-user information of the user A).

The system-operator receives the mail (D41), and registers the additional user-information including the approving-user information in the central system 303 (D42).

Next, the system-operator creates an additional user-information file (XML file) (D43) . This file includes an order-placing ID and the password, etc. which have been assigned for an additional user B in the same manner as the above-described user-information file in step D14 in FIG. 4, and additionally includes information for setting the user B as an additional user when that file is read by the previously registered user A.

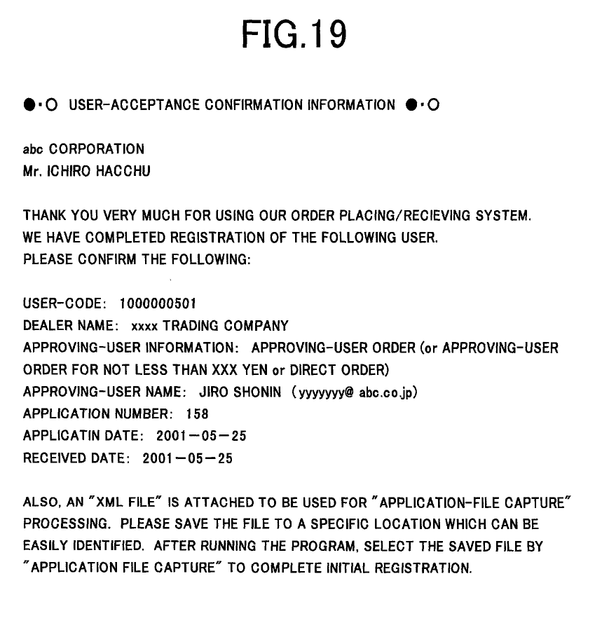

After this, the system-operator creates the E-mail as shown in FIG. 19, and attaches the additional user-information file to be sent to the user A (D44).

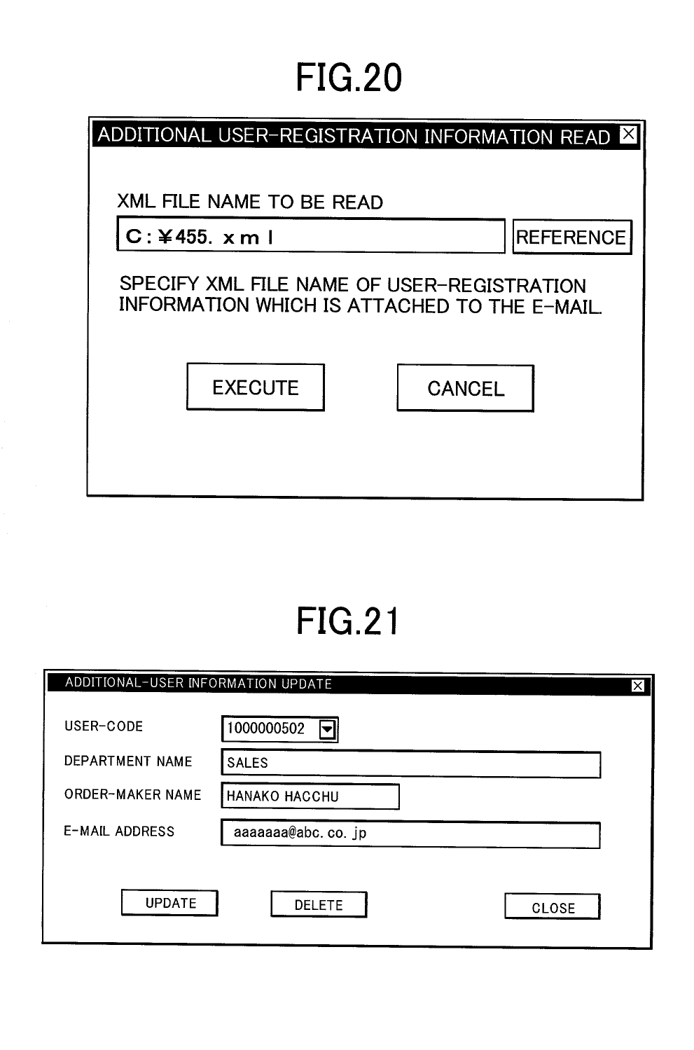

The user A receives the E-mail and confirms the content (U34), and then by reading the attachment file shown in FIG. 20 (U35), the user A becomes possible to place orders for the additional user B thereafter.

When changing the additional user-information (changing a department name, an order-maker, and a mail address), in the example described above, the user A selects “additional user-information update” on the screen in FIG. 17, and selects, from the pull-down menu, the user-code of additional user (for example, additional user B) to be processed on the screen in FIG. 21. Then by overwriting the information to be changed and clicking “update”, the updated additional user-information is sent to the system operator.

The system-operator updates the additional user-information in the central system by this additional user-information.

Further, in order to delete an additional user, the additional user to be processed may be displayed on the screen in FIG. 21, and then the “delete” button is clicked.

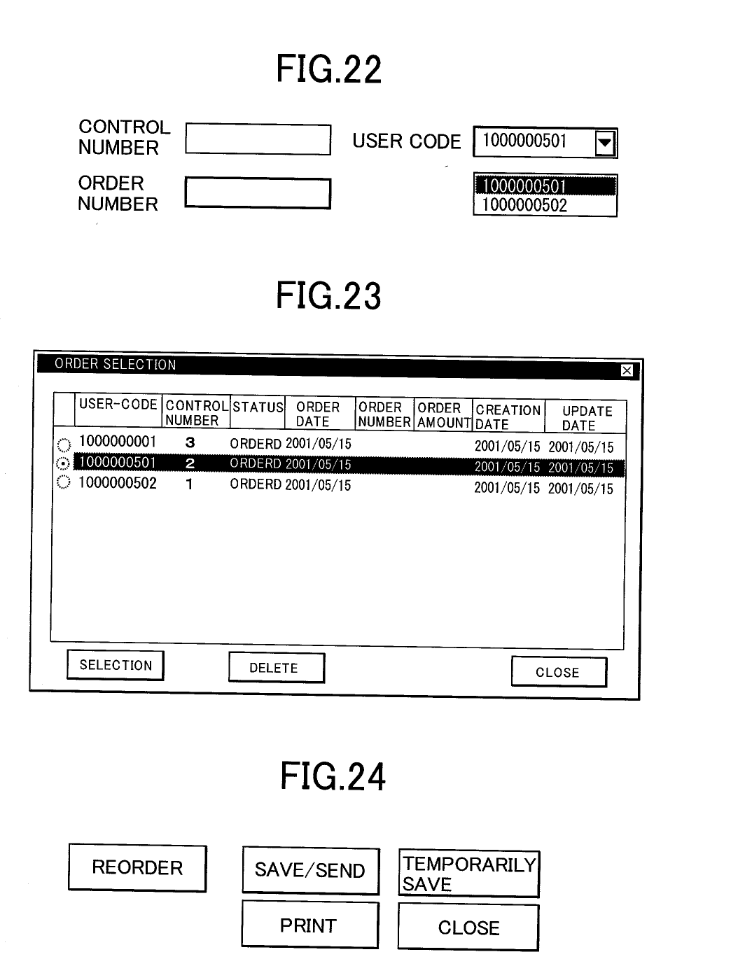

For placing a new order, on the order-placing screen, as shown in FIG. 22, a pull-down menu which includes user-codes of both the original user A and an additional user B is shown. Thus by selecting a desired user-code, the processing is performed as the order by that user. In FIG. 22, only two user-codes are shown, however, in general, the original user-code A and the user-codes of a plurality of additional users registered as additional users are displayed. By repeating selection of a user-code and order-placing processing, it is possible to place orders for a plurality of users. In this regard, for example, when a user A places orders for himself/herself and for an additional user B, the distribution destinations of the products are the user A and the user B, respectively.

Also, a further function of the order-placing/receiving method according to the present invention is a re-order processing based on the previous order data. This means that the previous order data is stored as a history in the user 100 side, and when the user 100 places orders, a list of previous order contents by each user is displayed by calling up the order-selection screen as shown in FIG. 23.

When the user 100 selects one of the previous order from this list, the content of the order is displayed on the screen, which is not shown in the figure. If the same order-content as the previous one is re-ordered, by clicking “re-order” in FIG. 24, placing the order of the same items with the same quantities is performed.

In this case, it is desirable to allow item change, item addition, quantity change and so on. By this means, when the user places an order with the same content with the previous order, the user does not need to start from selecting a product, thus the order-placing operation is simplified drastically.

When saving the previous order history is not required, the user selects “delete” in FIG. 23.

What is claimed is:

1. A method for placing/receiving an order using electronic mail in an order-placing/receiving system having an order-maker and an order-receiver in an environment where electronic mail is available, comprising:
storing, at the order-maker's side, order-information for products into an electronic-mail attachment file, automatically converting the order-information into a predetermined language format, and sending the electronic mail to the order-receiver; and
automatically reconverting, at the order-receiver 's side, the order-information in a received electronic-mail attachment file to extract the order data in order to allocate order and then instruct delivery.

2. A method for placing/receiving an order using electronic mail according to claim 1, further comprising:
entering, at the order-receiver's side, order-confirmation information including the order data and the order allocation result into the message of the electronic mail and storing the information into an attachment file; and automatically converting the order-confirmation information into a predetermined language format in order to reply to the order-maker.

3. A method for placing/receiving an order using electronic mail according to claims 1 or 2, further comprising:
making, at the order-maker's side, the order-information using a spreadsheet-software template which is distributed by the order-receiver in advance; and storing the order-information into an attachment file.

4. A method for placing/receiving an order using an electronic mail according to claims 1 or 2,
wherein the predetermined language format is XML format.

5. A method for placing/receiving an order using an electronic mail according to claims 1 or 2,
wherein an approving-user, who gives an approval for the order content, is established by the order-maker in advance to be registered at the order-receiver's side, and the order-receiver validates the order-content included in the order-information and performs order processing when the approval of the approving-user is obtained after the order-receiver who has received the order-information sends the order-information to the approving-user.

6. A method for placing/receiving an order using an electronic mail according to claim 3,
wherein an approving-user, who gives an approval for the order content, is established by the order-maker in advance to be registered at the order-receiver's side, and the order-receiver validates the order-content included in the order-information and performs order processing when the approval of the approving-user is obtained after the order-receiver who has received the order-information sends the order-information to the approving-user.

7. A method for placing/receiving an order using an electronic mail according to claim 4,
wherein an approving-user, who gives an approval for the order content, is established by the order-maker in advance to be registered at the order-receiver's side, and the order-receiver validates the order-content included in the order-information and performs order processing when the approval of the approving-user is obtained after the order-receiver who has received the order-information sends the order-information to the approving-user.

8. A method for placing/receiving an order using electronic mail according to claim 5,
wherein the approval of the approving-user is always needed regardless of the order amount at one time.

9. A method for placing/receiving an order using electronic mail according to claim 6,
wherein the approval of the approving-user is always needed regardless of the order amount at one time.

10. A method for placing/receiving an order using electronic mail according to claim 7,
wherein the approval of the approving-user is always needed regardless of the order amount at one time.

11. A method for placing/receiving an order using electronic mail according to any one of claims 1 or 2,
wherein a previously registered order-maker sets an additional order-maker in advance and sends the additional order-maker information to the order-receiver, the order-receiver registers the additional order-maker information, and at the same time, sends the additional order-maker information to the previously registered order-maker to capture the information in the previously registered order-maker's terminal, thus the previously-registered order-maker can perform the order-placing processing for the additional order-maker.

12. A method for placing/receiving an order using electronic mail according to any one of claim 3,
wherein a previously registered order-maker sets an additional order-maker in advance and sends the additional order-maker information to the order-receiver, the order-receiver registers the additional order-maker information, and at the same time, sends the additional order-maker information to the previously registered order-maker to capture the information in the previously registered order-maker's terminal, thus the previously-registered order-maker can perform the order-placing processing for the additional order-maker.

13. A method for placing/receiving an order using electronic mail according to any one of claim 5,
wherein a previously registered order-maker sets an additional order-maker in advance and sends the additional order-maker information to the order-receiver, the order-receiver registers the additional order-maker information, and at the same time, sends the additional order-maker information to the previously registered order-maker to capture the information in the previously registered order-maker's terminal, thus the previously-registered order-maker can perform the order-placing processing for the additional order-maker.

14. A method for placing/receiving an order using electronic mail according to any one of claim 6,
wherein a previously registered order-maker sets an additional order-maker in advance and sends the additional order-maker information to the order-receiver, the order-receiver registers the additional order-maker information, and at the same time, sends the additional order-maker information to the previously registered order-maker to capture the information in the previously registered order-maker's terminal, thus the previously-registered order-maker can perform the order-placing processing for the additional order-maker.

15. A method for placing/receiving an order using electronic mail according to any one of claim 7,
wherein a previously registered order-maker sets an additional order-maker in advance and sends the additional order-maker information to the order-receiver, the order-receiver registers the additional order-maker information, and at the same time, sends the additional order-maker information to the previously registered order-maker to capture the information in the previously registered order-maker's terminal, thus the previously-registered order-maker can perform the order-placing processing for the additional order-maker.

16. A method for placing/receiving an order using electronic mail according to any one of claim 8,
wherein a previously registered order-maker sets an additional order-maker in advance and sends the additional order-maker information to the order-receiver, the order-receiver registers the additional order-maker information, and at the same time, sends the additional order-maker information to the previously registered order-maker to capture the information in the previously registered order-maker's terminal, thus the previously-registered order-maker can perform the order-placing processing for the additional order-maker.

17. A method for placing/receiving an order using electronic mail according to any one of claim 9,
wherein a previously registered order-maker sets an additional order-maker in advance and sends the additional order-maker information to the order-receiver, the order-receiver registers the additional order-maker information, and at the same time, sends the additional order-maker information to the previously registered order-maker to capture the information in the previously registered order-maker's terminal, thus the previously-registered order-maker can perform the order-placing processing for the additional order-maker.

18. A method for placing/receiving an order using electronic mail according to any one of claim 10,
wherein a previously registered order-maker sets an additional order-maker in advance and sends the additional order-maker information to the order-receiver, the order-receiver registers the additional order-maker information, and at the same time, sends the additional order-maker information to the previously registered order-maker to capture the information in the previously registered order-maker's terminal, thus the previously-registered order-maker can perform the order-placing processing for the additional order-maker.

19. A method for placing/receiving an order using electronic mail according to any one of claims 1 or 2,
wherein the order-maker and the order-receiver store previous order-information as a history, and by the order-maker's selection of the order-information from the history, placing and receiving a re-order using the order-information are possible.

20. A method for placing/receiving an order using electronic mail according to any one of claim 3,
wherein the order-maker and the order-receiver store previous order-information as a history, and by the order-maker's selection of the order-information from the history, placing and receiving a re-order using the order-information are possible.

21. A method for placing/receiving an order using electronic mail according to any one of claim 5,
wherein the order-maker and the order-receiver store previous order-information as a history, and by the order-maker's selection of the order-information from the history, placing and receiving a re-order using the order-information are possible.

22. A method for placing/receiving an order using electronic mail according to any one of claim 6,
wherein the order-maker and the order-receiver store previous order-information as a history, and by the order-maker 's selection of the order-information from the history, placing and receiving a re-order using the order-information are possible.

23. A method for placing/receiving an order using electronic mail according to any one of claim 7,
wherein the order-maker and the order-receiver store previous order-information as a history, and by the order-maker's selection of the order-information from the history, placing and receiving a re-order using the order-information are possible.

24. A method for placing/receiving an order using electronic mail according to any one of claim 8,
wherein the order-maker and the order-receiver store previous order-information as a history, and by the order-maker's selection of the order-information from the history, placing and receiving a re-order using the order-information are possible.

25. A method for placing/receiving an order using electronic mail according to any one of claim 9,
wherein the order-maker and the order-receiver store previous order-information as a history, and by the order-maker's selection of the order-information from the history, placing and receiving a re-order using the order-information are possible.

26. A method for placing/receiving an order using electronic mail according to any one of claim 10,
wherein the order-maker and the order-receiver store previous order-information as a history, and by the order-maker's selection of the order-information from the history, placing and receiving a re-order using the order-information are possible.

27. A method for placing/receiving an order using electronic mail according to any one of claim 11,
wherein the order-maker and the order-receiver store previous order-information as a history, and by the order-maker's selection of the order-information from the history, placing and receiving a re-order using the order-information are possible.

28. A method for placing/receiving an order using electronic mail according to any one of claim 12,
wherein the order-maker and the order-receiver store previous order-information as a history, and by the order-maker's selection of the order-information from the history, placing and receiving a re-order using the order-information are possible.

29. A method for placing/receiving an order using electronic mail according to any one of claim 13,
wherein the order-maker and the order-receiver store previous order-information as a history, and by the order-maker's selection of the order-information from the history, placing and receiving a re-order using the order-information are possible.

30. A method for placing/receiving an order using electronic mail according to any one of claim 14,
wherein the order-maker and the order-receiver store previous order-information as a history, and by the order-maker's selection of the order-information from the history, placing and receiving a re-order using the order-information are possible.

31. A method for placing/receiving an order using electronic mail according to any one of claim 15,
wherein the order-maker and the order-receiver store previous order-information as a history, and by the order-maker's selection of the order-information from the history, placing and receiving a re-order using the order-information are possible.

32. A method for placing/receiving an order using electronic mail according to any one of claim 16,
wherein the order-maker and the order-receiver store previous order-information as a history, and by the order-maker's selection of the order-information from the history, placing and receiving a re-order using the order-information are possible.

33. A method for placing/receiving an order using electronic mail according to any one of claim 17,
wherein the order-maker and the order-receiver store previous order-information as a history, and by the order-maker's selection of the order-information from the history, placing and receiving a re-order using the order-information are possible.

34. A method for placing/receiving an order using electronic mail according to any one of claim 18,
wherein the order-maker and the order-receiver store previous order-information as a history, and by the order-maker's selection of the order-information from the history, placing and receiving a re-order using the order-information are possible.
